(19) United States
(12) Patent Application Publication
(10) Pub. No.: US 2011/0081473 A1
(43) Pub. Date: Apr. 7, 2011

(54) FOOD INGREDIENT HAVING MILK TASTE-ENHANCING ACTION, PRODUCTION METHOD THEREOF, METHOD OF ENHANCING MILK TASTE OF FOOD OR SEASONING AND MILK TASTE-ENHANCED MILK-BASED HARD CANDY

(75) Inventors: Shinichi Hamasaki, Yamatokooriyama-shi (JP); Taiji Matsukawa, Yamatokooriyama-shi (JP); Akito Kamihoriuchi, Yamatokooriyama-shi (JP); Kenji Ushio, Yamatokooriyama-shi (JP); Takeki Matsui, Yamatokooriyama-shi (JP); Yasumasa Yamada, Yamatokooriyama-shi (JP); Ichiro Yamada, Yamatokooriyama-shi (JP)

(73) Assignee: UHA MIKAKUTO CO., LTD., Yamatokooriyama-shi (JP)

(21) Appl. No.: 12/894,711

(22) Filed: Sep. 30, 2010

(30) Foreign Application Priority Data
Oct. 1, 2009 (JP) 2009-229797
Oct. 1, 2009 (JP) 2009-229798

(51) Int. Cl. A23G 3/46; A23G 3/42

(52) U.S. Cl. 426/580; 426/650

(57) ABSTRACT

An object of the invention is to provide a food ingredient having strong milk taste-enhancing action without providing coarse taste, a production method thereof, a method of improving milk taste, a milk-based hard candy, in particular a milk-based nonsugar hard candy, having a delicious milk taste that is produced with a food ingredient that can replace part or most of the dairy product at low cost.

The present invention relates to a food ingredient having milk taste-enhancing action, prepared by heating an aqueous solution containing an amino acid mixture containing at least three kinds of amino acids selected from valine, proline, isoleucine, lysine, glutamic acid and arginine as the principal components and a carbohydrate. The total amount of the at least three kinds of amino acids selected from valine, proline, isoleucine, lysine, glutamic acid, and arginine is preferably 70 wt % or more with respect to the total amount of all amino acids.

### TECHNICAL FIELD

The present invention relates to a new food ingredient having milk taste-enhancing action and a production method thereof. The present invention also relates to a method of enhancing milk taste of a food or a seasoning. The present invention also relates to a milk taste-enhanced milk-based hard candy.

### BACKGROUND ART

It is known that amino acids and carbohydrates are much involved in expression of the taste of foods. It is also known that amino acids and carbohydrates react with each other under heat, causing various changes in flavor. Such a change can also be experienced in actual diet, and the change in flavor of boiled food and broiled meat is said to be partially caused by Maillard reaction. There are many proposed methods of improving fragrance and taste by using the phenomenon of the reaction between amino acids and carbohydrates, but there is still no available method of enhancing milk taste.

For example, many methods of using the heat reaction between amino acids and carbohydrates generate flavor. These methods not only use the reaction substrates of amino acids and carbohydrates originally contained in food, but also use these substrates deliberately added to the food. Many of the reactions relate to a flavor with desired fragrance and a method of producing it efficiently by using the Maillard reaction.

There are many proposed method including a method of improving the flavor of a food by generating the flavor by heating a mixture of proline and rhamnose in a sealed state and adding the flavor to the food (Patent Document 1), a method of producing a chocolate-like flavored substance by reacting valine, leucine, isoleucine alone or an amino acid mixture containing at least one of them with a carbohydrate under heat in the presence of water, adding alcohols to the reaction product, and aging the mixture (Patent Document 2), a coffee taste substance having a coffee-like flavor, prepared by mixing basic amino acids and a carbohydrate at a particular blending ratio and heating the mixture in the presence of propylene glycol and/or glycerol (Patent Document 3), a method of producing an almond- or sponge cake-like fragrance composition, characterized by reacting lysine or arginine or the hydrochloride salt thereof with sugars under heat in the presence of lecithin (Patent Document 4), a method of extracting a flavor component from a mixture of amino acids or peptides and a reducing sugar (Patent Document 5), a method of producing a roast-fragrance flavor additive from amino acids or the derivatives thereof and a saccharide (Patent Document 6), a method of producing an additive having a meat-like taste from a paste mixture containing at least one free amino acid source and at least one reducing sugar (Patent Document 7) and the like. The traditional methods above are methods of obtaining a flavor by thermal reaction of amino acids and sugars in the presence of water, organic solvent, oils and others, and various methods, such as reaction in a tightly sealed container and use of an alcohol or emulsifier, are devised for efficient production of a high-strength flavor. However, none of these methods is intended to produce a hardly-volatile taste-enhancing substance that enhances the taste itself. In addition, each of these additives has its characteristic fragrances and thus, causes limitation that the desired fragrance is not generated when the additive is added to a food or seasoning and also a problem in flexibility of use.

There were many studies made by using the thermal reactions between amino acids and carbohydrates such as Maillard reaction, as described above, but there is no available technology directly related to the milk taste-enhancing action. There are still many unexplained facts in the reaction mechanism of the thermal reaction between amino acids and carbohydrates, and for example, the complicated reaction mechanism of the Maillard reaction itself is yet to be understood completely even now. Difficulty of technological development based on theory would be the reason for prohibited establishment of a technology sufficient for industrial application.

There are also methods of using particular amino acids in foods or drinks. It is known that amino acids have a significant influence on the flavor of foods, but it is not sufficiently clear which kind of flavor is generated according to the balance (composition and content) of amino acids and the combination and reaction with other additional components. For that reason, various attempts has been conventionally made.

For example, proposed is a method of producing a meat product having mature flavor, characterized by adding a composition containing L-glutamic acid, L-cysteine, L-methionine, L-leucine and L-arginine at a particular rate or adding a mixture of the amino acid composition and other amino acids (Patent Document 8). Although the method is effective for meat products, there is no description of its application for milk taste enhancement. There is also no description of the need for heat treatment.

Proposed is a method of adding methionine in a particular amount for improvement of the umami and kokumi characteristic of egg (Patent Document 9). However, the effect is limited to egg, and there is no description of the effect for milk taste enhancement.

Proposed is a liquid seasoning that tastes sufficiently salty, although its sodium chloride content is low, which was prepared by adding particular amounts of aspartic acid and glutamic acid (Patent Document 10). It is also effective to liquid seasonings such as soy sauce, but there is no description concerning milk taste enhancement.

Proposed are a non-fermented food having fermented milk-like flavor and a production method thereof (Patent Document 11). It proposes a non-fermented food having fermented milk-like flavor that contains several amino acids including L-glutamic acid in particular amounts and a production method thereof. Because it is not needed to carry out the lactate fermentation by lactic bacteria, it is possible to obtain fermented milk-like food superior in storage stability, easily by the method. However, the invention may be applicable to high-acidity fermented foods, but there is no description of it being applied to unfermented dairy products without sourness.

Proposed as an example of use of amino acids in milk-containing foods is a milk-containing coffee drink, characteristically prepared by adding a basic substance and/or a basic amino acid to a coffee preparation, mixing it with a milk preparation and heat-sterilizing the mixture (Patent Document 12). It is aimed at preventing solidification during mixing with the milk preparation and precipitation after heat sterilization and reducing the addition amounts of the emulsifier and the paste, and not aimed at enhancing milk taste.

Hereinafter, studies conducted for improvement of milk flavor will be described. Milk-containing foods are familiar to our lives and available really abundantly. Examples thereof include, but are not limited to, drinks such as milk, processed milks and milk drinks; fermented foods such as cheese and yoghurt; breads; desserts such as ice creams; confectioneries such as biscuits, tablets and candies; fresh cakes such as cakes; foods such as stews, and the like. Possibly because milk is familiar to us, as it is the first food taken by human when born, there is no doubt in the fact that we feel pleasant when we taste milk. For that reason, the level required to make people taste sufficiently delicious with a milk-containing product is high, and the hurdle in producing a dairy product satisfying the required level is high. Milk-containing foods lower in milk flavor are not accepted by people, and thus, it is a very important objection in the food industry, to develop a high-milk flavor food at a level that it tastes sufficiently delicious. Recent increasing health orientation demanded development of low-calorie foods, in particular foods containing a restricted amount of fresh cream or butter that is important for expression of milk flavor, and thus, it is important in the food industry to overcome the technological hurdle in enhancing the milk flavor properly in a product design containing a smaller amount of milk fat or milk components.

There have been many efforts made to enhance the milk flavor. Proposed are milk-like flavors as well as raw materials and preparations for enhancement of milk flavor and improvement of flavor, and the processing methods thereof.

Ingredients and preparations for milk flavor and butter flavor are proposed (Patent Documents 13 to 16). These ingredients and preparations are aimed at flavor development, and, although they have a certain fragrance-enhancing effect when added in small amount, the rich-bodied taste characteristic of dairy product cannot be provided with such a flavoring agent. In addition, the flavoring agents have a disadvantage that the strength thereof generally decreases as they are lost by vaporization in heat processing steps and thus, have a limited action.

There are also many studies conducted from an approach different form flavor development. Proposed is a method of improving the milk flavor of a powdery dairy product by addition of a yeast autolysate to the powdery dairy product (Patent Document 17). However, the step of preparing the solution for addition is complicated in the method and thus, the method demands elongated period and higher cost.

Although foods and drinks containing a phosphorylated oligosaccharide as taste improver were proposed (Patent Document 18), the step of extracting and purifying the phosphorylated oligosaccharide from potato is complicated and demands elongated period and higher cost. A milk-containing product improved in milk taste by using sucralose as its milk-taste improver was proposed (Patent Document 19) but, because sucralose is a synthetic high-sweetness sweetener, addition of it leads to rapid increase in sweetness, prohibiting use of it only for the purpose of enhancing the milk taste.

Proposed are a milk flavor-providing agent of a condensed milk prepared by removing milk fat particles from butter milk by centrifugation and then concentrating the butter milk by 2-step ultrafiltration and a production method thereof (Patent Document 20). Similarly proposed are a method of providing a food with milk flavor, characterized by removing milk fat particles from butter milk by centrifugation, drying the condensed milk obtained by ultrafiltration for a powder containing colloid-dispersed components, and adding the powder to the food and a milk flavor-providing agent (Patent Document 21). The butter milk is a byproduct during butter production, and has problems such as restriction of raw material supply, need for control for example of decomposition, and complexity of the step for preparing a desired addition solution. It also contains fat, which restricts the amount of the flavor-providing agent added to low-calorie foods.

Proposed is a milk-flavored soybean protein preparation containing soybean protein that has no soybean odor characteristic of soybean and having a milk flavor similar to the milk with animal proteins (Patent Document 22). However, in such a case too, the preparation contains fat, because soybean protein, milk-flavored fat are essential, and thus, the addition amount thereof to low-calorie foods is restricted. The soybean protein may also have an adverse effect on the physical properties, when the preparation is added to a processed food.

Proposed are a method of producing a milk flavor improver characterized by being prepared by bringing a cone powder in contact with fat at a temperature lower than the boiling point of water and a food containing the milk flavor enhancer (Patent Document 23). In such a case too, the preparation contains fat ingredient, because cone powder and fat are essential, and thus, the addition amount thereof to low-calorie foods is restricted. The cone-derived components may also have an adverse influence on physical properties, when the preparation is added to a processed food.

Proposed are a method of enhancing the milk flavor of a dairy product by adding a powder obtained by pulverization of brown rice or forcibly geminated brown rice to a dairy product-containing food or drink and heating the mixture and a food or drink thus obtained (Patent Document 24). In such a case too, the brown rice may have an adverse effect on physical properties during application of the powder to processed foods. There is a description that the particle diameter of the brown rice powder is preferably 50 μm or less, but it inevitably leads to precipitation during storage for example when added to a drink.

Although a method of enhancing the milk taste by adding an amino-carbonyl reaction product from peptide and carbonyl compound as an active ingredient to a dairy product was proposed (Patent Document 25), the product is often influenced by the taste of the protein, source of the peptide, in the method, causing a disadvantage of high cost, even if the peptide is synthesized.

The examples described above are methods aimed at improving the milk flavor, but all of them have their problems. On the other hand, studies on the method not directly aimed at improving the milk flavor but aimed at enhancing the taste were also made. These methods may be applicable for improvement of milk flavor, and thus, traditional methods for improvement of taste will be described below.

The taste of foods varies significantly and each food has its characteristic taste. Taste includes five tastes: sweetness, sourness, bitterness, saltiness and umami, and there is additionally kokumi as a taste not included in the five tastes. Pursuit of taste has been made aggressively. Examples of the umami substances include amino acids such as sodium glutamate, nucleic acid-related compounds such as sodium inosinate and the like, and these substances have their characteristic umami tastes. In addition, amino acid- and nucleic acid-based umami substances are known to have a synergic effect, and thus, there are developed many seasonings in combination thereof. However, such synthetic umami improvers prepared in combination of these compounds often show simple taste, not the complicated umami characteristic of food or drink, and thus have a disadvantage of unnatural taste.

Of course, natural product-derived extracts, mainly including yeast extracts, animal meat extract, sea food extracts, vegetable extracts and others, have been used to provide a food or drink with a taste closer to the natural complicated taste, and there are many related Patent Documents disclosed (e.g., Patent Document 26). However, these natural extracts inevitably contain the natural raw material-derived taste and flavor, usually causing a problem of restriction of application and use amount. There are many related separation/purification methods for reduction of the foreign or coarse taste in these natural extracts, but these methods had problems such as deterioration in strength of the taste and increase of processing cost. For example, proposed was a taste improver characterized by containing a solvent extract of tea (Patent Document 27), but it has restriction in flexibility in use because it derives from tea, and an example of purification with a synthetic absorbent is also shown.

A food or drink flavor improver containing a sugar cane-derived distillate as its active ingredient was proposed (Patent Document 28), but a purification step with a synthetic absorbent is also needed for production of this flavor improver.

It was shown that it is possible to improve taste of a liquid with agar, by making the agar molecules suspended in the liquid (without gelation) instead of making the liquid gelated with the agar molecules (Patent Document 29), but there is a significant restriction on use of it from the points of physical properties.

There are also many disclosed reports on flavor and taste improvers containing no natural extract. Proposed is a method of providing a food or drink with kokumi by using a pyrazine compound, a nitrogen-containing six-membered ring heterocyclic compound (Patent Document 30), but the method has a disadvantage that high cost and larger labor are needed for its synthesis and purification. It is possible to produce the compound in reaction of an amino acid such as glycine or lysine with a ribose, but the ribose is not a major raw material used as a food ingredient and the ribose may adversely influence the taste and processing compatibility unless it is purified.

There are additionally reports concerning addition of kokumi. A method of adding a heated mixture of gelatin and tropomyosin (Patent Document 31) is restricted in its application, because it contains gelatin. Although there was an attempt to provide a kokumi-providing seasoning by binding of a peptide (not limited) with a sugar in Maillard reaction (Patent Document 32), the seasoning unfavorably retains the bitterness of peptide. A new glycopeptide and the like having a kokumi-providing function are proposed (Patent Document 33). However in preparation of these compounds, the desired peptide cannot be prepared simply by heating amino acids with carbohydrates, and thus, chemical synthesis is needed. Thus, such a glycopeptide has a significant problem in cost. On the other hand if the protein is hydrolyzed with enzyme, there is a need for purification, and the hydrolysate, if not purified, is influenced by the bitterness of other peptides simultaneously generated and the flavor of the protein-derived materials.

Accordingly, there exists a need for a highly taste-enhancing food ingredient higher in flexibility of use that has an action to enhance the natural and complicated taste of a food or seasoning and is free from coarse taste or foreign fragrance, in particular for such a food ingredient characteristically enhancing milk taste.

On the other hand, hard candies are a kind of candies consumed all over the world and, in particular, so-called scotch candies produced by using a dairy product such as fresh cream or butter forms a large market in the world. For example, “Werther's Original” (trade name) is a scotch candy that is popular all over the world and also favorite in Japan. A milk candy “Tokuno Milk 8.2” (trade name) manufactured by the applicant also forms an established market in Japan. Each of them, which uses a much dairy product as its raw material and the favorable taste of milk as much as possible, has already establishes a large market as a milk-based hard candy.

However, the price of the dairy products, which are essential for the milk-based hard candies, fluctuates significantly, depending on the supply-consumption balance and the production amount of fresh milk, and it is often difficult to control properly the raw material cost of the candy containing a dairy product in large amount.

On the other hand, in the recent hard candy market, there was a trend toward removal of sugar (sucrose) mainly in throat drops and there is an increasing demand toward removal of sugar also for hard candies other than throat drops.

Recent increase in consciousness of health and metabolic syndrome may be cited as the reason for it, and there is currently an increased need for prevention of tooth decay and also for reduction of calorie, although delicious products are desired. Nonsugar fruit candy and coffee candy are already commercially available actually to satisfy such a need.

However, there is no such a trend toward sugar removal from milk-based hard candies, which form a globally significantly larger market in Japan, compared to other candies.

It is because it is needed to reduce the content of sugars to less than 0.5 g in 100 g of candy to make a hard candy sugarless, and thus, the addition amount of the dairy product, which is essential for the delicious taste of milk candy, is restricted significantly, as it contains lactose. Actually, nonsugar milk candies commercially available are extremely poor in deliciousness, compared to sugar-based milk candies that may contain any dairy products in any amounts, even though various modifications for improvement, such as use only of a milk-based flavoring agent and use of a low lactose-containing fresh cream, butter or milk protein hydrolysate in a limited amount, were made.

On the other hand, various proposals for enhancement and improvement of milk taste of various products including candies were made.

For example, proposed is a method of enhancing the milk flavor of dairy products by adding a powder obtained by pulverization of brown rice or forcibly geminated brown rice to a dairy product-containing food or drink and heating the mixture (Patent Document 24). Brown rice indeed has a fragrant taste and an action to enhance milk taste when added in a small amount. However, further addition of brown rice for enhancement of milk taste may result in distinct expression of the fragrance of brown rice, prohibiting desired enhancement of milk taste. There is also a description that the brown rice powder preferably has a particle diameter of 50 μm or less, but the brown rice powder, if it is added to a candy as it is milled and the particle diameter thereof is reduced to 50 μm or less, causes a problem of roughness, not smoothness, when tasted.

Also proposed is a milk flavor-enhancing agent prepared by bringing a cone powder into contact with a fat at a temperature not higher than the boiling point of water (Patent Document 23). There is a description in the proposal of a contact-treatment temperature not higher than the boiling point of water, and the contact treatment at a temperature higher than the boiling point of water is described to be ineffective in the Comparative Example. A concentration step at a temperature of 100° C. or higher is essential in production of a hard candy; the proposal does not describe a case when a material treated at a temperature not higher than the boiling point of water is used, then, it is processed at a temperature of the boiling point or higher; and the proposal may be applicable to processing for example of butter, cream or milk at a temperature of water boiling point or lower, but may not be applicable to processing of hard candies that are concentrated at a temperature of 100° C. or higher.

Also proposed is a method of improving the milk taste by addition of sucralose (Patent Document 19). Sucralose is a high-sweetness sweetener, and increases sweetness even when added in small amount and enhances milk taste by its sweetness to some degree. However, further addition of sucralose leads rather to enhancement only of sweetness, not to improvement of milk taste, thus restricting improvement of milk-taste.

Also proposed is addition of the amino-carbonyl reaction product from a peptide and a carbonyl compound to a milk solid-containing food or drink (Patent Document 25). However, the proposal has problems that it demands much labor and high cost, because a reaction product having a desired molecular weight should be produced for example in enzyme reaction, alkali treatment and others, and the product is often influenced by the taste of the protein of the peptide source.

Also proposed is a flavor improver for dairy products containing a fraction prepared by fractionating the extract obtained by extraction of roasted coffee with water, a polar organic solvent or the mixture thereof as its active ingredient (Patent Document 34). According to the proposal, the coffee fraction is effective even when added in an extremely small amount; but, the step of extracting coffee with solvent contains for example a step of ultrafiltration or chromatography; the method has a disadvantage that only limited fractions obtained thereby can be used, and thus has problems that it demands very large labor and that use of the other fractions should be also be considered.

Proposed additionally is a seasoning for dairy products, containing a yeast extract and skim milk powder or skim milk, that contains sodium 5′-guanylate at 3 wt % or more (Patent Document 35). Generally, yeast extracts enhance kokumi, but often cause a problem of so-called “yeast odor” derived from yeast, and thus, such a seasoning is often restricted in its application. There is no description in the proposal that the yeast odor decreases, and thus, the yeast extract is restricted in its application and addition amount. Therefore, enhancement and addition of milk taste is restricted, when the yeast extract is used within the range that gives no yeast odor.

Also proposed is a milk flavor-providing agent, characterized by being a powder containing colloidally dispersed components prepared by removing milk fat particles from butter milk by centrifugation and subsequent ultrafiltration of the butter milk and drying a concentrated solution of butter milk (Patent Document 21). Butter milk is a byproduct generated during butter production, and has problems such as limited supply of the raw material supply, need for control for example of decomposition, or complexity of the steps such as of centrifugation, ultrafiltration and drying for preparing a desired addition solution.

Also proposed are a butter flavor enhanced in milk flavor and butter flavor (Patent Document 15), a flavoring agent preparation containing a particular disulfide compound that provides and enhances natural, fresh and rich taste of milk (Patent Document 36), a natural milk flavor efficiently providing light taste, sharp aftertaste, natural fragrance and fresh milk taste, which contains a flavor eluate obtained by bringing milk in contact for example with a porous polymer and eluting the adsorbed components (Patent Document 37), a milk flavor-providing or improving agent containing (Z)-6-octenal added in an extremely trace amount (Patent Document 16), and a method of producing a cooked cocoa flavor, by mixing a cacao liquor or cacao powder with amino acids, sugars and water, heating the mixture at a temperature of 80° C. to 100° C., adding a milk or dairy product to the heated product and heating the mixture additionally at a temperature of 40 to 80° C. (Patent Document 38). All of the methods above are considered to be effective as a flavoring agent or in providing the flavor to some degree. However, only the flavor is improved by these methods, and it is difficult to achieve the sufficiently rich taste (so-called, rich-bodied taste) and the fragrance and taste characteristic of milk with the flavoring agent. In addition, the flavoring agent has a disadvantage that it strength is generally weakened by vaporization thereof in heat processing steps.

There is also a proposal that the top note strength and the consistency in strength of fragrance and flavor for example of a candy are improved distinctively, by making a taste preparation, which is obtained by adding, to a melted mixture of sugar and glutinous starch syrup, a liquid or paste-like water-dispersible flavor obtained by making a scarcely water-soluble flavor substance dispersible in water by using sugars and proteins, another flavoring agent preparation, a fruit juice or a raw milk material, and amino acids and sugars and heating the mixture, contained therein (Patent Document 39). The proposal describes that, even for a candy produced at high temperature, top note (early fragrance) of the flavoring agent, residual of the flavoring agent, and consistency in strength of the fragrance and flavor of the candy can be obtained, even when the flavoring agent is mixed at high temperature. It is a proposal for modification of a flavoring agent, and it is difficult to provide a candy with sufficiently rich-bodied taste, favorable taste and milk taste with the flavoring agent.

There is also a proposal of a milk-containing coffee drink prepared by adding a strongly basic substance and/or a basic amino acid to a coffee preparation, mixing it with a milk preparation and then heating and sterilizing the mixture (Patent Document 38). It is aimed at preventing solidification during mixing of milk preparation, preventing precipitation after heating sterilization, and reducing the amount of the emulsifier or adhesive added, and not aimed at enhancing milk taste.

Also proposed is a method of enhancing sweetness and kokumi of foods by using a yeast extract having a free amino acid content of 5 wt % or more (Patent Document 40). The addition amount thereof is significantly restricted, because the yeast extract has a characteristic yeast odor and slight variation in amino acid balance of the yeast extract leads to expression of characteristic flavors of respective amino acids to some distinctive degree.

There is also a proposal concerning a preparation for improvement of the flavor of fermented milk containing L-glutamic acid, L-leucine, DL- or L-alanine, L-serine, L-arginine, L-tyrosine, L-phenylalanine, L-histidine, DL- or L-methionine (Patent Document 41). According to the proposal, such a preparation may be effective to products prepared at low temperature, such as yoghurt and drink yoghurt, to a certain degree. However, because concentration of hard candies is carried out in a relatively severe temperature condition of 110 to 150° C., the preparation in the amino acid combination described therein is still an amino acid preparation having a problem in milk taste enhancement of hard candies, because the flavor for example of L-phenylalanine and L-leucine fluctuates significantly when they are heated.

There are also proposals aimed at removing sugars in milk-based candies (Patent Documents 42 and 43). In these proposals, a low-lactose milk component prepared by treating milk or fresh cream with membrane is used as a raw material. According to these methods, the milk component may be used in a greater amount as a raw material because the lactose content is actually lower. However, the addition amount is limited, and there is still a problem to overcome in order to obtain a truly delicious milk-based candy.

There is thus a need for a raw material replaceable as part or most of a dairy product, which is produced from relative cheap raw materials by a relative simple method, and in addition, and also a need for a calorie-free or sugar-free milk-based hard candy that is delicious.

### CITATION LIST

### Patent Literature

Patent Document 1 JP-B No. 48-25508

Patent Document 2 JP-B No. 55-11300

Patent Document 3 JP-B No. 58-11987

Patent Document 4 JP-B No. 59-48974

Patent Document 5 JP-A No. 5-207860

Patent Document 6 JP-B No. 6-6038

Patent Document 7 JP-B No. 7-57169

Patent Document 8 JP-B No. 6-16691

Patent Document 9 JP No. 4202099

Patent Document 10 JP No. 4060843

Patent Document 11 JP-A No. 10-276670

Patent Document 12 JP No. 3702176

Patent Document 13 JP No. 3516041

Patent Document 14 JP No. 3851945

Patent Document 15 JP No. 3362092

Patent Document 16 JP No. 4319361

Patent Document 17 JP-A No. 6-319448

Patent Document 18 JP-A No. 2002-253164

Patent Document 19 JP-A No. 2000-135055

Patent Document 20 JP No. 3004912

Patent Document 21 JP No. 3059380

Patent Document 22 JP-A No. 7-99892

Patent Document 23 JP-A No. 2000-4822

Patent Document 24 JP-A No. 2005-21047

Patent Document 25 JP-A No. 2007-202492

Patent Document 26 JP No. 2950756

Patent Document 27 JP-A No. 2005-137286

Patent Document 28 JP No. 4037035

Patent Document 29 JP-A No. 2006-180792

Patent Document 30 JP No. 3929170

Patent Document 31 JP-A No. 10-276709

Patent Document 32 JP-A No. 2002-335904

Patent Document 33 WO No. 2004/096836

Patent Document 34 JP-A No. 2008-05457

Patent Document 35 JP-A No. 2008-237037

Patent Document 36 JP-A No. 2008-092890

Patent Document 37 JP No. 3516041

Patent Document 38 JP No. 3507913

Patent Document 39 JP-A No. 10-099023

Patent Document 40 JP-A No. 2009-044978

Patent Document 41 JP No. 3714790

Patent Document 42 JP-A No. 10-004885

Patent Document 43 JP-A No. 10-179036

### SUMMARY OF INVENTION

### Technical Problem

An object of the present invention, which was made under the circumstances above, is to provide a food ingredient having strong milk taste-enhancing action and yet giving smaller coarse taste, a production method thereof, and a method of enhancing the milk taste of a food or seasoning by using the food ingredient.

Another object of the present invention is to produce a milk-based hard candy, in particular a milk-based nonsugar hard candy, with rich favorable milk taste at low cost by substituting part or all of a dairy product with the food ingredient.

### Solution to Problem

The inventors tried to develop a food ingredient having milk taste-enhancing action at a high efficiency not possible hitherto that is produced in a simple and convenient production process using thermal reaction. For that reason, first, traditional methods concerning the thermal reaction between amino acids and carbohydrates and then, flavor-improving methods by using amino acids were studied intensively, and in addition, flavor-enhancing methods different from these methods above were analyzed and classified comprehensively. However, there was no description or suggestion of the milk taste-enhancing action in the traditional methods. In other words, the present invention, which is limited only to the “milk taste-enhancing action,” was made, based on a completely new technological concept.

After intensive studies in search of a new food ingredient enhancing the milk taste of foods and seasonings, the inventors have found that a new food ingredient prepared by heating an aqueous solution containing an amino acid mixture containing at least three kinds of amino acids selected from valine, proline, isoleucine, lysine, glutamic acid and arginine as the principal components and a carbohydrate improves the milk taste of various foods and seasonings effectively, and made the present invention.

The present invention relates to:

(1) a food ingredient having milk taste-enhancing action, prepared by heating an aqueous solution containing an amino acid mixture containing at least three kinds of amino acids selected from valine, proline, isoleucine, lysine, glutamic acid and arginine as the principal components and a carbohydrate (hereinafter, referred to as the food ingredient according to the present invention);
(2) the food ingredient having milk taste-enhancing action according to (1) above, wherein the total amount of the at least three kinds of amino acids selected from valine, proline, isoleucine, lysine, glutamic acid and arginine is 70 wt % or more with respect to the total amount of all amino acids;
(3) the food ingredient having milk taste-enhancing action according to (1) or (2), wherein the amino acids selected are valine, proline, isoleucine, lysine, glutamic acid and arginine;
(4) a method of producing the food ingredient having milk taste-enhancing action according to any one of (1) to (3) above, comprising a step of mixing an amino acid mixture containing at least three kinds of amino acids selected from valine, proline, isoleucine, lysine, glutamic acid and arginine as the principal components and a carbohydrate with water, heating the aqueous mixed solution under an open system at 70° C. to 150° C., and evaporating the generated fragrance components;
(5) a method of enhancing the milk taste of a food or seasoning, characterized by adding the food ingredient having milk taste-enhancing action according to any one of (1) to (3) to the food or the seasoning to a final solid matter concentration of 1 ppm to 10,000 ppm;
(6) a milk taste-enhanced milk-based hard candy having a carbohydrate and a dairy product as the principal components, characterized by containing the food ingredient having milk taste-enhancing action according to any one of (1) to (3) above in an amount as solid matter of 0.001 to 1.0 wt %;
(7) the milk taste-enhanced milk-based hard candy according to (6) above, wherein the carbohydrate used in preparation of the hard candy is one or more compounds selected from the group consisting of glutinous reducing maltose syrup, glutinous reducing starch syrup, reducing palatinose, xylitol, erythritol, lactitol, mannitol and sorbitol; and
(8) a method of producing the milk taste-enhanced milk-based hard candy according to (6) or (7) above, characterized by having a step of obtaining a food ingredient having milk taste-enhancing action by mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components, and a step of mixing and dissolving the food ingredient with a carbohydrate and a dairy product under heat and then concentrating the solution under heat.

### ADVANTAGEOUS EFFECTS OF INVENTION

The food ingredient according to the present invention has an action to enhance the natural milk taste, the kokumi and the rich-bodied taste such as the thickness and width of taste, of milk characteristic of a food or drink, without damaging its milk taste, when added to the food or drink.

It is thus possible, by using the food ingredient according to the present invention replacing part or most of the milk component contained in a food or drink, to provide the food or drink with milk taste without use of the milk component in a great amount and to add other effective components that could not be blended when such a milk component is used.

In addition, the milk-based hard candy according to the present invention, which is enhanced in its milk taste, can solve the problems of limited supply and high cost. it is also possible according to the present invention to produce a milk-based nonsugar hard candy, which is considered to be hardly produced because of the difficulty of using the dairy product abundantly. In this way, it is possible with the present invention to satisfy the needs of various consumers more efficiently, compared to when only a dairy product is used.

### DESCRIPTION OF EMBODIMENTS

Hereinafter, the present invention will be described.

In the present invention, the “milk taste” is a taste that makes people feel favorable, because of the five tastes of sweetness, sourness, bitterness, saltiness and umami (savoriness) as well as kokumi characteristic of milk and the interaction thereof. In addition, the milk taste of a raw milk material such as butter, cheese or milk powder, which makes people taste favorable because of the five tastes and the kokumi characteristic of milk and the interaction thereof, is also included in the milk taste.

The term “taste enhancement”, as used in the present specification, means enhancement of the taste of food favorably tasted by people, based on five tastes of sweetness, sourness, bitterness, saltiness and umami as well as kokumi and the interaction thereof, to a favorable taste naturally deeper, thicker and wider.

The term “milk taste enhancement” means enhancement of the milk taste to a more favorable taste naturally deeper, thicker and wider.

The term “coarse taste” means the five tastes, flavor and kokumi of a raw material different from those of the raw milk material. The term “foreign taste” means a taste that differs more than coarse taste from the milk taste and is thus completely different from the milk taste.

Amino acids in the present specification are L-amino acids, unless specified otherwise. In addition, the amino acids for use in the present invention may be amino acid salts, and examples thereof for use include amino acid salts such as sodium and potassium salts and also amino acid hydrochloride salts that can be used as a food without any problem. The amino acid in the present invention is in the state of free amino acid or amino acid salt, but the content thereof, as used in the present invention, is a value determined as the free amino acid.

The food ingredient having milk taste-enhancing action according to the present invention (hereinafter, referred to also as the food ingredient according to the present invention) is prepared by heating an aqueous solution containing amino acids including at least three kinds of amino acids selected from valine, proline, isoleucine, lysine, glutamic acid, and arginine as the principal component and a carbohydrate.

Origin of the amino acids used as raw materials is not particularly limited, and the amino acids may be industrially produced/purified amino acids, crude extracts extracted from natural products, or products purified form the crude extracts. However, use of purified amino acids is preferable, from the viewpoint of contamination of natural raw material-derived components, because it is desired to reduce the coarse taste as much as possible.

The carbohydrate used as a raw material is not particularly limited, but preferably a monosaccharide or a disaccharide, because the action is stronger, and examples thereof include glucose, fructose, sucrose, maltose, lactose, galactose and the like. The carbohydrate may not particularly be a reducing sugar. In addition, the carbohydrate may be a sugar alcohol such as xylitol. It may be a mixture of multiple carbohydrates, and isomerized sugars such as fructose/glucose liquid sugar and glucose/fructose liquid sugar are preferable from the viewpoint of cost. It may be an oligosaccharide or a high-molecular weight carbohydrate such as glutinous starch syrup or dextrin. A low-purity carbohydrate such as brown sugar can also be used; and a carbohydrate-rich material such as honey or fruit juice syrup can also be used, if the material is favorably compatible in flavor with the food to which the food ingredient according to the present invention is added.

Caramel flavor may be added by previously heating of these carbohydrates according to application, but because the caramel flavor has a significant influence on the final flavor, heating should be regulated strictly to obtain a desired caramel flavor.

The food ingredient according to the present invention is prepared by heating an aqueous solution containing amino acids including at least three kinds of amino acids selected from valine, proline, isoleucine, lysine, glutamic acid, and arginine as the principal components and a carbohydrate. Examples of the amino acids used include combinations of at least three kinds of amino acids selected from valine, proline, isoleucine, lysine, glutamic acid and arginine contained as essential components, but the kinds of the amino acids in the combination are not limited thereto. However, the total amount of the amino acids used in the combination is preferably 70 wt % or more with respect to the total amount of all amino acids contained in the food ingredient. In addition to the amino acids selected from these six kinds of amino acids, other amino acids that are suitable for the final desired flavor may be chosen and used, but the content of the other amino acids is preferably less than 30 wt % of the total amount of all amino acids from the same reason.

As for the combination of at least three kinds of amino acids selected from valine, proline, isoleucine, lysine, glutamic acid and arginine, combination of all six kinds of amino acids: valine, proline, isoleucine, lysine, glutamic acid and arginine; combination of five kinds of amino acids: valine, proline, isoleucine, lysine and arginine; and combination of three kinds of amino acids: valine, proline and isoleucine are preferable, because the combinations have particularly high milk taste-improving action.

The heat reaction between amino acids and a carbohydrate is carried out in the state of aqueous solution. The solvent for use may be water or water containing an added organic solvent such as ethanol or an added oil, but the solvent should be selected not to generate foreign flavor finally, and the rate of water in the solvent is preferably 70% (V/V) or more.

The ratio of the amino acids to the carbohydrate is not particularly limited, but the ratio of the total amino acid amount to the total carbohydrate amount by weight is preferably 1:99 to 99:1, more preferably, 1:9 to 9:1.

The concentration of the amino acids added to the solvent such as water is preferably 0.001 to 10 wt %, more preferably 0.01 to 5 wt %. An amino acid concentration of less than 0.001 wt % may lead to decrease of the milk taste-enhancing action, while an amino acid concentration of more than 10 wt % to elongation of the operation for solubilizing the amino acids and also generation of unexpected burnt odor during heating.

Seasoning substances other than the amino acids and the carbohydrate may be added as needed to the solvent such as water. Examples thereof include salt, nucleic acid-related ingredients, various seasoning extracts, peptide-based seasoning ingredients and the like. The salt may be a purified salt or a low-purity salt such as rock salt. Examples of the nucleic acid-related ingredients include purified inosinic acid or the salts thereof, guanylic acid or the salts thereof, and extracts such as nucleic acid-rich soft roe extract. An extract favorably selected from natural extracts such as yeast extracts, meat extracts, sea food extracts and vegetable extracts is used as the seasoning extract. Major known peptide-based seasoning ingredients are protein hydrolysates, and typical examples thereof include enzyme hydrolysates of proteins such as of corn, wheat, casein, whey and yeast and the purified products thereof. However, the addition amount of the nucleic acid-related ingredient, the various seasoning extract or the peptide-based seasoning ingredient, which has its characteristic flavor, should be kept to 20 wt % or less with respect to the total amount of the amino acids in the food ingredient according to the present invention finally obtained.

In the present invention, addition of a milk-derived raw material (excluding enzyme hydrolysates of raw milk materials such as casein and whey described above) to the solvent such as water for enhancement of milk taste is unfavorable. Addition of a milk-derived raw material prohibits desired progress of the reaction between amino acids and carbohydrates, generating coarse taste, and leads to deterioration of the milk taste-enhancing action itself. Examples of the milk-derived raw materials include creams, butters, butter oils, cheeses, concentrated whey, ice creams, condensed milks, defatted condensed milks, sugarless condensed milks, sugarless defatted condensed milks, sweetened condensed milks, sweetened defatted condensed milks, powdered whole milks, skim milk powders, cream powders, whey powders, protein-concentrated whey powders, butter milk powders, sweetened milk powders, modified milk powders, fermented milks, lactic bacteria drinks (only those having a solid nonfat milk content of 3.0 wt % or more) and milk drinks.

The aqueous solution containing amino acids and a carbohydrate (in the present invention, the term aqueous solution is used when the solvent other than water is also mixed) is prepared by mixing the amino acids and the carbohydrate with water.

The aqueous solution prepared shows desired milk taste-enhancing action only after heat treatment. The heat treatment includes a step of heating the aqueous mixed solution under an open system at 70° C. to 150° C. and vaporizing the fragrance components generated.

The aqueous solution prepared is heated under an open system at 70° C. to 150° C., as described above. The phrase “open system” in the present specification includes a system that is not sealed structurally and also a system that is sealed structurally but equipped with a device for removal of the substances. Specifically, a reaction system, if it is sealed structurally but equipped with an exhaust device and the atmosphere in the container is discharged spontaneously or forcibly for example through a pipe connected to the headspace region of the sealed reaction container, is included in the open system. In addition, a circulating apparatus in which the atmosphere in the headspace region, which is not in contact with external air, is recovered and circulated once again to the reaction container after passage through a deodorizing apparatus is also included in the open system. Further, a circulating apparatus in which the solution therein, which is not in contact with external air, is recirculated into the reaction container after passage through a deodorizing apparatus, is also included in the open system.

The heating means is not particularly limited, and may be a method of raising the temperature of the reaction container by means of direct fire, steam or electricity, a method of raising the temperature of the aqueous solution directly by means of steam or electricity, a method of raising the temperature of the aqueous solution with microwave or the like. The heating temperature is 70° C. to 150° C. A heating temperature lower 70° C. than may result in insufficient reaction, prohibiting desired action, while a heating temperature of higher than 150° C. may lead to browning of the aqueous solution and generation of coarse taste with burnt odor. The heating period is not particularly limited, and the heating is terminated when desired action is generated. However when the efficiency of the step is considered, the heating period is preferably 5 minutes to 120 minutes, and the heating is desirably terminated in the state of aqueous solution, because heating to complete exsiccation may generate burnt odor. The pressure during heating may be normal pressure or alternatively, reduced or increased pressure.

The heating leads to progress of the Maillard reaction, generating fragrance by vaporization of the fragrance components. The volatile fragrance components generating the fragrance are seemingly amino acids. Such a fragrance, which may restricts application of the food ingredient according to the present invention, should be removed efficiently. However, the fragrance components, which mostly have a low boiling point and are thus very volatile, are preferably heated in a cap-less container that is not blocked from external air or a container having an exhaust route for discharge of the steam and the fragrance components generated. It is also desirable to remove the fragrance components efficiently by heating the mixture under reduced pressure. Alternatively, a method of removing the fragrance components by heating the aqueous solution and supplying steam into the aqueous solution simultaneously may be used. Purging of the aqueous solution by bubbling, for example, with air, carbon dioxide gas or nitrogen gas is also effective. It is also possible to raise the removal efficiency by agitating the aqueous solution under heat. It is not necessary to use all of the various methods above, and only a single method or a combination thereof may be used. A reaction container that can be pressurized or depressurized may also be used. Combination thereof, such as repetition of increased pressure, normal pressure and reduced pressure, is also possible. In the case of a circulating apparatus, the atmosphere in the headspace region and the aqueous solution during heat treatment can be recovered and recirculated into the reaction container after reduction of the fragrance components by passage through an odor absorbent such as activated carbon. As described above, the aqueous solution after heating may be subjected to an additional treatment for removal of the fragrance components.

However, it is undesirable to remove the fragrance components after reaction in a complete closed system, because there are various fragrance components generated in excess amounts, causing a problem of fragrance generation and thus increasing the labor for removal thereof. Removal of fragrance components with organic solvent is effective in the table scale, but it causes problems of solvent cost and separation cost in industrial operation; alternatively in the case of a production method of removing the fragrance components by steam distillation after reaction in a closed system, the fragrance components to be removed remain in the aqueous solution at high concentration, demanding elongated period for removal thereof thus, both methods are extremely ineffective and undesirably in the present invention.

As described above, it is possible to obtain a fragrance-reduced aqueous solution having milk taste-enhancing action by removing the fragrance components under heat. The aqueous solution thus obtained may be used as it is, as a solution after it is diluted with various liquids, as a powder prepared by a suitable drying method generating no burnt odor, or as a powder prepared by mixing a base material such as dextrin for improvement in processing compatibility with the aqueous solution and drying the mixture. These solutions and powders are all included in the food ingredients having milk taste-enhancing action according to the present invention.

The food ingredient according to the present invention thus obtained does not show much coarse taste, umami or kokumi, but has a property to show its action distinctively when added to a food or drink for enhancement of milk taste. Specifically, it enhances the taste characteristic of the raw milk material, which makes people feel favorable, based on the flavor, sweetness, sourness, umami, kokumi and by interaction thereof, into a favorable rich-bodied taste naturally deeper, thicker and wider. Thus, the food ingredient according to the present invention can be used as a food additive for enhancement of milk taste.

In addition, the food ingredient according to the present invention, which is prepared from food ingredients and food additives, is very safe and can be produced at low cost.

The food ingredient according to the present invention can increase the milk taste of various foods when added thereto. It can be used the in a state favorable for processing operation, whether it is in the state of aqueous solution or powder or in the state in which the powder is redissolved in liquid. It may be added finally to a final food or seasoning or may be used in the phase of adding raw materials or in a processing step. In any case, use of it is determined, as compatibility with the taste of each food and the processing step is taken into consideration. There is no problem caused, if it is heated after addition, and the milk taste-enhancing action is often shown more distinctively by additional heating. In such a case, addition before heating is desirable.

The food or drink to which the food ingredient according to the present invention is applied is not limited, if the food or the seasoning has a milk flavor, even if it is slight, or a raw milk material is used as part of the raw materials. Examples thereof include a wide variety of foods including confectionery such as candies, gummies, snacks, rice crackers, chocolates, tablet, gums, ice creams and jellies; favorite foods such as snacks for example containing cheese as a raw material; drinks such as milk drinks, carbonate drinks, fruit juice drinks, and health drinks; liquors such as carbonated distilled liquors; processed foods such as meat balls, sausages, stews and curries; and the like. It is preferably added when the processability of the step is higher and enhancement of the milk taste is favorable, and specifically, it may be added in the step when the raw material mixture is supplied, in the intermediate step after supply thereof, or during pulverization or coating in the final step, although it may depend on the processing method. The food ingredient according to the present invention can be added to seasonings such as dressings. Alternatively, the food ingredient according to the present invention can be added to breads and noodles. The food ingredient according to the present invention may be added to fermented foods such as cheeses and yoghurts in the raw material-supplying phase before fermentation or in the phase after fermentation. The food ingredient according to the present invention is particularly superior in compatibility with saltiness, and shows the milk taste-enhancing action more efficiently when used in combination with salt, and thus, it can be used favorably for salty milk-containing products. Since the food ingredient according to the present invention has very limited coarse taste, it gives, for example, a processed fruit food higher in milk taste, as it is added to a fruit-based processed food that shows milk taste and sourness.

In addition to these processed foods, the food ingredient according to the present invention can also be used during dining at home. In such a case, it is highly beneficial when it is used as a home-use seasoning such as dressing or liquid seasoning.

For example, the food ingredient according to the present invention enhances the milk taste of a food or seasoning when it is added to the food or seasoning at a final solid matter concentration of 1 ppm to 10,000 ppm. It may be added in the state of aqueous solution, if the concentration thereof as solid matter is in the range of 1 ppm to 10,000 ppm.

Hereinafter, a milk-based hard candy will be described as an example of a food containing the food ingredient according to the present invention.

The milk-based hard candy is a hard candy containing carbohydrates and dairy products as the principal components, characterized in that it contains the food ingredient according to the present invention in an amount of 0.001 to 1.0 wt % as solid matter.

Even when a soy sauce or a miso containing much amino acids or a mixture of 20 kinds of amino acids is added to a milk-based hard candy, it does not normally enhance the milk taste because of interference by the flavor of itself or gives a milk candy showing foreign odor. In contrast, the milk-based hard candy according to the present invention, which contains the added food ingredient according to the present invention prepared by heating particular amino acids and a carbohydrate under an open system, can enhance the milk taste naturally and efficiently.

In the present specification, the milk-based hard candies include milk hard candies as well as other hard candies containing dairy products in more than a little amount such as scotch hard candies, yoghurt hard candies, milk coffee hard candies, strawberry milk hard candies and milk mint hard candies. In addition to the sugar-containing hard candies, nonsugar hard candies are also included in the hard candies of the present invention.

The milk-based hard candy is prepared, for example, by mixing the food ingredient according to the present invention with carbohydrates and dairy products, heating and dissolving the mixture, and then, concentrating the mixture under heat.

Similarly to the carbohydrates and dairy products, the food ingredient according to the present invention may be added in the phase of raw material supply or after concentration under reduced pressure and before molding. Similarly to the main raw materials for the hard candy such as sugar and glutinous starch syrup, the food ingredient having milk taste-enhancing action is preferably added in the stage of raw material supply and exposed once again to the temperature for conversion to hard candy, because the milk taste is further enhanced.

The food ingredient according to the present invention is contained in the milk-based hard candy containing carbohydrates and dairy products as the principal components in an amount of 0.001 to 1.0 wt %, preferably 0.008 to 0.3 wt %, and more preferably 0.02 to 0.1 wt %, as solid matter. When the content of the food ingredient having milk taste-enhancing action is less than 0.001 wt %, it is not possible to obtain the milk taste-enhancing action. Alternatively, when it is more than 1.0 wt %, the amino acid-derived taste becomes greater than the milk component-derived taste, resulting in imbalance of taste and prohibiting production of a delicious milk-based hard candy.

A carbohydrate that can be used for the food ingredient according to the present invention may be used as the carbohydrate for use in production of the milk-based hard candy. Alternatively if a nonsugar milk-based hard candy is desirably produced, the carbohydrate used is preferably one or more compounds selected from the group consisting of glutinous reducing maltose syrups, glutinous reducing starch syrups, reducing palatinose, xylitol, erythritol, lactitol, mannitol, and sorbitol. Care should be give to the content of the sugar alcohols such as xylitol, erythritol, lactitol, mannitol and sorbitol, because they are carbohydrates that can crystallize easily.

The dairy product used in the milk-based hard candy is not particularly limited, if it is a food ingredient usable in hard candies. Examples thereof include creams, butters, butter oils, cheeses, concentrated whey, ice creams, condensed milks, defatted condensed milks, sugarless condensed milks, sugarless defatted condensed milks, sweetened condensed milks, sweetened defatted condensed milks, powdered whole milks, skim milk powders, cream powders, whey powders, protein-concentrated whey powders, butter milk powders, sweetened milk powders, modified milk powders, fermented milks, lactic bacteria drinks (only including those having a nonfat milk solid content of 3.0 wt % or more) and milk drinks. Alternatively, the dairy product used in the nonsugar milk-based hard candy is preferably a fresh cream or a butter having a relatively smaller lactose content. It can be used at a carbohydrate content in the range of less than 0.5 g in 100 g of the candy. In addition, dairy products such as condensed milk and milk powder can be used, but dairy products with high lactose content are unfavorable, because their content in hard candy is limited.

The method of mixing the food ingredient having milk taste-enhancing action with a carbohydrate and a dairy product, the method of dissolving the mixture obtained under heat, or the method of concentrating the hot solution obtained are not particularly limited, if it is a method commonly used in preparation of hard candies.

The milk-based hard candy according to the present invention may contain, as needed, food additives used in candies such as acidifiers, fruit juices, flavoring agents, colorants, food fibers, vitamins, minerals, oils and fats, emulsifiers, and high-sweetness sweeteners (aspartame, glycyrrhizin, saccharin, stevioside, rebaudioside, dulcin, alitame, trichlorosucrose, thaumatin, Acesulfame potassium, sucralose, etc.), in the range that does not impair the advantageous effects of the invention. These food additives are preferably mixed together with the food ingredient having milk taste-enhancing action, the carbohydrate and the dairy product above.

The hot concentrate obtained may be molded as it is filled and cooled in a desired mold, and the molding thus obtained may be subjected to post-treatments such as cutting, oiling and sugar coating.

### EXAMPLES

Hereinafter, the present invention will be described in more detail with reference to Examples, but it should be understood that the present invention is not limited thereby. In the description of Examples, the content of amino acids is a value as free amino acids. The “part” in Example is part by weight.

### (I-1) Preparation Example of Food Ingredients Having Milk Taste-Enhancing Action

### Reaction Solutions I-1 and I-2

Valine, proline, isoleucine, sodium glutamate, arginine (respectively manufactured by Kyowa Hakko Bio Co., Ltd., the same shall apply in the following Examples) and lysine (manufactured by Ajinomoto Co., Inc., lysine hydrochloride salt, the same shall apply in the following Examples) were weighed respectively in particular amounts (Table I-1), and the mixture was diluted with water to a volume of 300 mL.

### [Table 1]

Then, the amino acid solution and 2.5 g of a fructose/glucose liquid sugar (“High Fructo M”; manufactured by Nihon Cornstarch Corporation, the same shall apply in the following Examples) were placed in a pot without cap, and the mixture was boiled under heat (approximately 100° C.) for 30 minutes in an electromagnetic cooker (manufactured by Twinbird Corporation, the same shall apply in the following Examples) under agitation. Fragrance components were evaporated with the steam by agitation. The aqueous solution was diluted to a volume of 300 mL after heating, to give an inventive product (reaction solution I-1).

Subsequently, valine, proline, isoleucine, sodium glutamate, arginine and lysine were weighed each in particular amounts (Table I-2) and the mixture was diluted with water to a volume of 900 mL.

### [Table 2]

Then, the amino acid solution and 7.5 g of the fructose/glucose liquid sugar were placed in a vacuum pot equipped with an exhaust device and heated under agitation under the condition of −550 mm Hg and 90° C. for 20 minutes. Fragrance components were evaporated with the steam and discharged out of the exhaust device. The aqueous solution was diluted again with water to a volume of 900 mL after heating, to give an inventive product (reaction solution I-2).

### (2) Preparation Example of Food Ingredient

### Test Solution I-1

Valine, proline, isoleucine, sodium glutamate, arginine and lysine were weighed each in particular amounts (Table I-1) and the mixture was added with 2.5 g of the fructose/glucose liquid sugar and diluted with water to a volume of 300 mL. The preparation was not heated and used as a test solution I-1.

### (I-3) Milk Taste-Enhancing Action of Reaction Solutions I-1 and I-2 and Test Solution I-1 to Low-Calorie Milk Hard Candy

### Hereinafter, Referred to as Low-Calorie Candy

Subsequently, the milk taste-enhancing action of each of the reaction solutions I-1 and I-2 and the test solution I-1 was evaluated from the sample obtained by using it as a raw material for low-calorie candy. Water in the amount identical with the sample was used as control. A panel test was conducted by 10 examiners, and the milk taste of the sample or control obtained was evaluated organoleptically. The “milk taste” was evaluated in ranks (1: weakest, 5: strongest) and the average was shown. It was comprehensive organoleptic evaluation in which the rank is higher when the coarse taste and the foreign taste are smaller and the milk taste is stronger and the rank is lower when the milk taste is weaker or the coarse or foreign taste is stronger. The sample was considered to have milk taste-enhancing action when the coarse or foreign taste is weaker and the milk taste is stronger.

### Control Example I-1

100 parts of sugar and 500 parts of a glutinous reducing maltose syrup were mixed and dissolved (100° C., the same shall apply in the followings Examples and Comparative Examples); 15 parts of fresh cream, 5 parts of butter, 10 parts of condensed milk, 10 parts of 6×-concentrated strawberry fruit juice, 0.8 part of emulsifier, and 100 parts of water were added thereto; and the mixture was concentrated in a vacuum pan under the condition of −650 mm Hg and 140° C., to give a low-calorie candy having a water content of 2.0 wt %.

### Example I-1

A low-calorie candy having a water content of 2.0 wt % was prepared in a manner similar to Control Example I-1, except that water was replaced with the reaction solution I-1.

### Example I-2

A low-calorie candy having a water content of 2.0 wt % was prepared in a manner similar to Control Example I-1, except that water was replaced with the reaction solution I-2.

### Comparative Example I-1

A low-calorie candy having a water content of 2.0 wt % was prepared in a manner similar to Control Example I-1, except that water was replaced with the test solution I-1.

### Comparison of Milk Taste Among Control Example I-1, Examples I-1 and I-2, and Comparative Example I-1

Subsequently, the low-calorie candies obtained in Control Example I-1, Example I-1, 1-2 and Comparative Example I-1 were evaluated in the organoleptic test (Table I-3).

### [Table I-3]

It was found that the low-calorie candies obtained in Examples I-1 and I-2 were weaker in coarse taste and foreign taste than that obtained in Control Example I-1 and that the milk taste thereof was enhanced distinctively. However, when the test solution I-1 without heat treatment was used, the low-calorie candy (Comparative Example I-1) was comparable in milk taste with that in Control Example I-1, indicating that there was almost no enhancement effect. The results demonstrated that the heat reaction of amino acids in a particular amino acid composition with a carbohydrate is important.

### (I-3) Examination of the Milk Taste-Enhancing Action to the Low-Calorie Candies of Reaction Solutions I-3 to I-55

### Examples I-3 to I-48 and Comparative Examples I-2 to I-8

As shown in Table I-4, various amino acids selected from valine, proline, isoleucine, sodium glutamate, arginine and lysine were mixed with each other in particular amounts, and the mixture was diluted with water to a volume of 300 mL. Then, each amino acid solution and 2.5 g of the fructose/glucose liquid sugar were placed in a cap-less pot, and the mixture was boiled in an electromagnetic cooker for 30 minutes under agitation. Fragrance components were evaporated with the steam and by agitation. The aqueous solution was diluted again with water to a volume of 300 mL after heating, to give an inventive product (reaction solution I-3 to I-43). In addition, reaction solutions I-44 to I-48 were prepared, as they are heated with the fructose/glucose liquid sugar similarly, as examples of the combination of amino acids having certain action. For preparation of many Comparative Examples of the amino acid preparations having no such an action, they are also heated with a fructose/glucose liquid sugar similarly, to give reaction solutions I-49 to I-55. The amino acid compositions of these reaction solutions are summarized in Table I-5.

### [Table I-4]

### [Table I-5]

A low-calorie candy was then prepared by using each reaction solution as a raw material and subjected to organoleptic evaluation. The low-calorie candy was compared with that in Control Example I-1 in the evaluation. A low-calorie candy having a water content of 2.0 wt % was prepared in a manner similar to Control Example I-1, except that water was replaced with each reaction solution. Table I-6 summarizes the reaction solutions used in Examples I-3 to I-48 and Comparative Examples I-2 to I-8 and the ranks determined by the organoleptic evaluation.

The results shown in Table I-6 show that the low-calorie candies obtained in Examples I-3 to I-48 have milk taste-enhancing action statistically significantly higher than that of Control Example I-1 and also have milk taste-enhancing action higher than those of Comparative Examples I-2 to I-8. In particular, the low-calorie candies obtained in Examples I-3 to I-46 were distinctively higher in milk taste-enhancing action.

### [Table I-6]

### (I-4) Examination of Milk Taste-Enhancing Action to Milk-Flavored Cookie of Reaction Solution I-1

### Example I-49, Control Example I-2 and Comparative Example I-9

The reaction solution I-1 and the test solution I-1 were freeze-dried each, to give powders (referred to as powder of reaction solution I-1 and powder of test solution I-1).

The ingredient composition of the cookie of Control Example I-2 is shown in Table I-7, the ingredient composition of the cookie of Example I-49 is shown in Table I-8, and the ingredient composition of the cookie of Comparative Example I-9 is shown in Table I-9.

First, a shortening was creamed; it is further creamed with added sugar; an aqueous solution of salt, a blowing agent (baking soda or ammonium bicarbonate), and skim milk powder was added thereto, and the entire mixture was creamed. The powder of reaction solution I-1 or the powder of test solution I-1 was then added and mixed; finally, wheat flour was added thereto; and the mixture was molded, after slight agitation, and baked at 190° C. for 13 minutes.

### [Table I-7]

### [Table I-8]

### [Table I-9]

Results of a similar organoleptic test of the cookies obtained are shown (Table I-10). The results showed that the evaluation rating of the milk-flavored cookie of Example I-49 is statistically significantly higher than that of Control Example I-2, but the evaluation rating of the milk-flavored cookie of Comparative Example I-9 is only slightly different from that of Comparative Example I-2. The results indicate that the powder of test solution I-1 without heat treatment has no milk taste-enhancing action, but the powder of reaction solution I-1 has a significant milk taste-enhancing action.

### [Table I-10]

### (I-6) Examination of the Milk Taste-Enhancing Action of Reaction Solution I-1 to Milk-Flavored Drink

### Example I-50, Control Example I-3 and Comparative Example I-10

The reaction solution I-1 and the test solution I-1 were added each to a commercially available low-fat milk in an amount of 1/200 volume, to give samples for organoleptic evaluation (Example I-50 and Comparative Example I-10). A mixture of a low-fat milk with water added in the same amount was used in Control Example I-3 and subjected to the organoleptic evaluation similarly (Table I-11).

### [Table I-11]

As a result, the evaluation rating of the milk-flavored drink of Example I-50 was statistically significantly higher than that of Control Example I-3, while that of Comparative Example I-10 is only slightly different form that of Control Example I-3. The results indicated that the test solution I-1 without heat treatment has no milk taste-enhancing action, while the reaction solution I-1 has significant milk taste-enhancing action.

### (I-6) Examination of Milk Taste-Enhancing Action of Reaction Solution I-1 to Milk-Flavored Seasoning

### Example I-51, Control Example I-4 and Comparative Example I-11

The reaction solution I-1 and the test solution I-1 were added each to a white source dressing, a commercially available milk-flavored seasoning, in an amount of 1/50 volume, to give samples for organoleptic evaluation (Example I-51 and Comparative Example I-11). The white source dressing with water added in the same amount was used as Control Example I-4 and subjected to the organoleptic evaluation similarly (Table I-12).

### [Table I-12]

The results showed that the evaluation rating of the white source dressing of Example I-51 is statistically significantly higher than that of Control Example I-4, while that of Comparative Example I-11 is only slightly different from that of Control Example I-4. The results indicated that the test solution I-1 without heat treatment has no milk taste-enhancing action, while the reaction solution I-1 has significant milk taste-enhancing action.

### PREPARATION EXAMPLES

### (II-1) Preparation Example of Food Ingredient Having Milk Taste-Enhancing Action

### Reaction Solution A

Valine, proline, isoleucine, sodium glutamate, arginine and lysine were weighed respectively in particular amounts (Table II-1) and the mixture was diluted with water to a volume of 300 mL.

### [Table II-1]

Then, the amino acid solution and 2.5 g of the fructose/glucose liquid sugar was placed in a cap-less pot and boiled under agitation in an electromagnetic cooker (approximately 100° C.) for 30 minutes. Fragrance components were evaporated with the steam and discharged out of the exhaust device. The aqueous solution was diluted to a volume of 300 mL after heating, to give a reaction solution A (its amino acid preparation is shown in Table II-1).

### (2) Preparation of Reaction Solutions B to J

Reaction solutions B to I were prepared (their amino acid compositions are shown in Table II-2 to II-9) in a manner similar to the reaction solution A, except that amino acids in the kinds and amounts shown in Table II-2 to II-10 were weighed.

Although the reaction solution J was the same in the kinds and amounts of the amino acids as the reaction solution A, it was a simple solution without heat reaction.

### [Table II-2]

### [Table II-3]

### [Table II-4]

### [Table II-5]

### [Table II-6]

### [Table II-7]

### [Table II-8]

### [Table II-9]

### [Table II-10]

### EXAMPLES

### Application to Milk-Based Hard Candy

### Control Example II-1

500 parts of sugar and 400 parts of glutinous starch syrup were mixed and dissolved (100° C., the same shall apply in the followings Examples and Comparative Examples);

100 parts of fresh cream, 20 parts of butter, 70 parts of condensed milk and 1.0 part of an emulsifier were added thereto; the mixture was concentrated in a vacuum pot under the condition of −550 mm Hg and 115° C., to give a milk hard candy having a water content of 3.0 wt %.

### Control Example II-2

1000 parts of glutinous reducing maltose syrup was mixed and dissolved; 100 parts of fresh cream, 20 parts of butter and 1.0 part of an emulsifier were added thereto; and the mixture was concentrated in a vacuum tank under the condition of −650 mm Hg and 145° C., to give a nonsugar milk hard candy having a water content of 1.5 wt %. The nonsugar milk hard candy of Control Example II-2 is a calorie-off hard candy, compared to the milk hard candy of Control Example II-1.

### Example II-1

500 parts of sugar and 400 parts of glutinous starch syrup were mixed and dissolved; 100 parts of fresh cream, 20 parts of butter, 70 parts of condensed milk, 1.0 part of an emulsifier and 200 parts of the reaction solution (A) prepared in Preparation example were added thereto; and the mixture was concentrated in a vacuum tank under the condition of −550 mm Hg and 115° C., to give a milk hard candy having a water content of 3.0 wt %. The milk hard candy thus obtained was definitely improved in milk flavor reliably from that of Control Example II-1, demonstrating its milk taste-enhancing action.

### Example II-2

A milk hard candy having a water content of 3.0 wt % was prepared in a manner similar to Example II-1, except that the reaction solution (A) was replaced with the reaction solution (B). The milk hard candy thus obtained was definitely improved in milk flavor reliably from that of Control Example II-1, demonstrating its milk taste-enhancing action.

### Example II-3)

A milk hard candy having a water content of 3.0 wt % was prepared in a manner similar to Example II-1, except that the reaction solution (A) was replaced with the reaction solution (C). The milk hard candy thus obtained was definitely improved in milk flavor reliably from that of Control Example II-1, demonstrating its milk taste-enhancing action.

### Example II-4

500 parts of sugar and 400 parts of glutinous starch syrup were mixed and dissolved; 100 parts fresh cream, 20 parts butter, 70 parts condensed milk, 1.0 part of an emulsifier and 10 parts of the reaction solution (A) prepared in Preparation example were added thereto; and the mixture was treated similarly to Example II-1, to give a milk hard candy having a water content of 3.0 wt %. The milk hard candy thus obtained was improved in milk flavor reliably from that of Control Example II-1, demonstrating that it has milk taste-enhancing action, although it is slightly lower in the action than that of Example II-1.

### Example II-5

500 parts of sugar and 400 parts of glutinous starch syrup were mixed and dissolved; 100 parts of fresh cream, 20 parts of butter, 70 parts of condensed milk, 1.0 part of an emulsifier and 214 parts of 20 time-concentrate of the reaction solution (A) prepared in Preparation example were added thereto; and the mixture was treated similarly to Example II-1, to give a milk hard candy having a water content of 3.0 wt %. The milk hard candy thus obtained was definitely improved in milk flavor reliably, compared to that of Control Example II-1, demonstrating that it has milk taste-enhancing action, although it is slightly lower in the balance of milk flavor than that of Example II-1.

### Example II-6

500 parts of sugar and 400 parts of glutinous starch syrup were mixed and dissolved; 50 parts of fresh cream, 10 parts of butter, 35 parts of condensed milk, 1.0 part of an emulsifier and 200 parts of the reaction solution (A) prepared in Preparation example were added thereto; and the mixture was treated similarly to Example II-1, to give a milk hard candy having a water content of 3.0 wt %. It was found that the milk hard candy thus obtained has the milk flavor equivalent to that of Control Example II-1, although the amount of the milk component blended is smaller, compared to that of Control Example II-1, demonstrating that it has milk taste-enhancing action and can be used as an alternative for the milk component.

### Example II-7

450 parts of sugar and 400 parts of glutinous starch syrup were mixed and dissolved; 100 parts of fresh cream, 20 parts of butter, 70 parts of condensed milk, 50 parts of caramel powder, 1.0 part of an emulsifier and 200 parts of the reaction solution (A) prepared in Preparation example were added thereto; and the mixture was treated similarly to Example II-1, to give a caramel hard candy having a water content of 3.0 wt %. The caramel hard candy thus obtained was definitely improved in milk flavor compared to that of Control Example II-1, demonstrating its milk taste-enhancing action.

### Example II-8

1000 parts of a glutinous reducing maltose syrup was mixed and dissolved; 100 parts of fresh cream, 20 parts of butter, 1.0 part of an emulsifier and 200 parts of the reaction solution (A) prepared in Preparation example were added thereto; and the mixture was treated in a vacuum pot under the condition of −650 mm Hg and 145° C., to give a nonsugar milk hard candy having a water content of 1.5 wt %. The nonsugar milk hard candy thus obtained was definitely improved in milk flavor, compared to that of Control Example II-2, demonstrating its milk taste-enhancing action.

### Example II-9

1000 parts of a glutinous reducing starch syrup was mixed and dissolved; 100 parts of fresh cream, 20 parts of butter, 1.0 part of an emulsifier and 200 parts of the reaction solution (A) prepared in Preparation example were added thereto; and the mixture was treated similarly to Example II-9, to give a nonsugar milk hard candy having a water content of 1.5 wt %. The nonsugar milk hard candy thus obtained was definitely improved in milk flavor compared to that of Control Example II-2, demonstrating its milk taste-enhancing action.

### Example II-10

1000 parts of reducing palatinose was mixed and dissolved; 100 parts of fresh cream, 20 parts of butter, 1.0 part of an emulsifier and 200 parts of the reaction solution (A) prepared in Preparation example were added thereto; and the mixture was treated similarly to Example II-9, to give a nonsugar milk hard candy having a water content of 1.5 wt %. The nonsugar milk hard candy thus obtained was definitely improved in milk flavor, compared to that of Control Example II-2, demonstrating its milk taste-enhancing action.

### Example II-11

500 parts of a glutinous reducing maltose syrup and 500 parts of a glutinous reducing starch syrup were mixed and dissolved; 100 parts of fresh cream, 20 parts of butter, 1.0 part of an emulsifier and 200 parts of the reaction solution (A) prepared in Preparation example were added thereto; and the mixture was treated similarly to Example II-9, to give a nonsugar milk hard candy having a water content of 1.5 wt %. The nonsugar milk hard candy thus obtained was definitely improved in milk flavor compared to that of Control Example II-2, demonstrating its milk taste-enhancing action.

### Comparative Example II-1

A milk hard candy having a water content of 3.0 wt % was prepared in a manner similar to Example II-1, except that the reaction solution (A) was replaced with the reaction solution (D). The milk hard candy thus obtained had a flavor different from the milk-based flavor and the milk taste thereof was not enhanced.

### Comparative Example II-2

A milk hard candy having a water content of 3.0 wt % was prepared in a manner similar to Example II-1, except that the reaction solution (A) was replaced with the reaction solution (E). The milk hard candy thus obtained had a flavor different from the milk-based flavor and the milk taste thereof was not enhanced.

### Comparative Example II-3

A milk hard candy having a water content of 3.0 wt % was prepared in a manner similar to Example II-1, except that the reaction solution (A) was replaced with the reaction solution (F). The milk hard candy thus obtained had a flavor different from the milk-based flavor and the milk taste thereof was not enhanced.

### Comparative Example II-4

A milk hard candy having a water content of 3.0 wt % was prepared in a manner similar to Example II-1, except that the reaction solution (A) was replaced with the reaction solution (G). The milk hard candy thus obtained had a flavor different from the milk-based flavor and the milk taste thereof was not enhanced.

### Comparative Example II-5)

A milk hard candy having a water content of 3.0 wt % was prepared in a manner similar to Example II-1, except that the reaction solution (A) was replaced with the reaction solution (H). The milk hard candy thus obtained had a flavor different from the milk-based flavor and the milk taste thereof was not enhanced.

### Comparative Example II-6

A milk hard candy having a water content of 3.0 wt % was prepared in a manner similar to Example II-1, except that the reaction solution (A) was replaced with the reaction solution (I). The milk hard candy thus obtained had a dashi (cooking stock) flavor different from the milk-based flavor and the milk taste thereof was not enhanced.

### Comparative Example II-7

500 parts of sugar and 400 parts of glutinous starch syrup were mixed and dissolved; 100 parts of fresh cream, 20 parts of butter, 70 parts of condensed milk, 1.0 part of an emulsifier and 2.0 parts of the reaction solution (A) prepared in Preparation example were added thereto; and the mixture was treated similarly to Example II-1, to give a milk hard candy having a water content of 3.0 wt %. The milk hard candy thus obtained had a taste not different from that of Control Example II-1 and the milk taste was not enhanced, because the addition amount of the reaction solution was too low.

### Comparative Example II-8

500 parts of sugar and 400 parts of glutinous starch syrup were mixed and dissolved; 100 parts of fresh cream, 20 parts of butter, 70 parts of condensed milk, 1.0 part of an emulsifier and 248 parts of 20 times-concentrate of the reaction solution (A) prepared in Preparation example were added thereto; and the mixture was treated similarly to Example II-1, to give a milk hard candy having a water content of 3.0 wt %. The milk hard candy thus obtained was inferior in the balance of taste and had a taste different from milk taste, and thus, the milk taste was not enhanced, because the addition amount of the reaction solution was too high.

### Comparative Example II-9

500 parts of sugar and 400 parts of glutinous starch syrup were mixed and dissolved; 100 parts of fresh cream, 20 parts of butter, 70 parts of condensed milk and 1.0 part of an emulsifier were added thereto; the mixture was concentrated similarly to Example II-1; 2 parts of a milk flavoring agent was added thereto, to give a milk hard candy having a water content of 3.0 wt %. The milk hard candy thus obtained was stronger in flavor than that of Control Example II-1, but the rich-bodied milk taste thereof is not different from that of Control Example II-1, indicating absence of the milk taste-enhancing action.

### Comparative Example II-10

500 parts of sugar and 400 parts of glutinous starch syrup were mixed and dissolved; 100 parts of fresh cream, 20 parts of butter, 70 parts of condensed milk, 1.0 part of an emulsifier and 200 parts of the reaction solution (J) prepared in Preparation example were added thereto; and the mixture was treated similarly to Example II-1, to give a milk hard candy having a water content of 3.0 wt %. The milk hard candy thus obtained has a milk taste slightly enhanced, compared to that of Control Example II-1, but the enhancement is far weaker than that of Example II-1, leaving a problem of low milk taste-enhancing action.

Evaluation results of the milk-based hard candies obtained in Control Examples II-1 to II-2, Examples II-1 to II-11, and Comparative Examples II-1 to II-10 are summarized in Tables II-11 and II-12. The results in Tables II-11 and II-12 show that all of the milk-based hard candies obtained in Examples II-1 to II-11 had a milk taste enhanced compared to those obtained in Control Examples II-1 and II-2.

The evaluation criteria used in Tables II-11 and II-12 are shown below. Evaluation was made by ten examiners, and the evaluation results provided by the greatest number of examiners are shown in Tables II-11 and II-12.

### <Milk Taste>

\textcircled{•}: Natural milk taste is enhanced sufficiently, compared to Control Examples II-1 and II-2

◯: Milk taste is enhanced, compared to Control Examples II-1 and II-2

Δ: Milk taste is enhanced slightly but insufficiently, compared to Control Examples II-1 and II-2

x: Milk taste is not enhanced or unnatural taste is added, compared to Control Examples II-1 and II-2

### [Table II-11]

### [Table II-12]

TABLE I-1
Amino acid composition of reaction solution I-1

| | |
|---|---|
| Arginine | 50 mg |
| Lysine | 50 mg |
| Isoleucine | 20 mg |
| Valine | 35 mg |
| Proline | 45 mg |
| Glutamic acid | 400 mg |

TABLE I-2
Amino acid composition of reaction solution I-2

| | |
|---|---|
| Arginine | 150 mg |
| Lysine | 150 mg |
| Isoleucine | 60 mg |
| Valine | 105 mg |
| Proline | 135 mg |
| Glutamic acid | 1200 mg |

TABLE I-3

| Sample | Average |
|---|---|
| Control Example I-1 | 1.9 |
| Example I-1 | 3.6 |
| Example I-2 | 3.7 |
| Comparative Example I-1 | 2.1 |

TABLE I-4
Amino acid composition of each reaction solution

| | | |
|---|---|---|
| Amino acid composition of | Val | 35 mg |
| reaction solution I-3 | Pro | 45 mg |
| | Ile | 30 mg |
| | Lys | 50 mg |
| | Glu | 400 mg |
| Amino acid composition of | Val | 35 mg |
| reaction solution I-4 | Pro | 45 mg |
| | Ile | 40 mg |
| | Lys | 50 mg |
| | Arg | 60 mg |
| Amino acid composition of | Val | 35 mg |
| reaction solution I-5 | Pro | 45 mg |
| | Ile | 30 mg |
| | Arg | 50 mg |
| | Glu | 400 mg |
| Amino acid composition of | Val | 35 mg |
| reaction solution I-6 | Pro | 45 mg |
| | Arg | 60 mg |
| | Lys | 50 mg |
| | Glu | 400 mg |
| Amino acid composition of | Val | 35 mg |
| reaction solution I-7 | Arg | 60 mg |
| | Ile | 30 mg |
| | Lys | 50 mg |
| | Glu | 400 mg |
| Amino acid composition of | Arg | 60 mg |
| reaction solution I-8 | Pro | 45 mg |
| | Ile | 30 mg |
| | Lys | 50 mg |
| | Glu | 400 mg |
| Amino acid composition of | Val | 50 mg |
| reaction solution I-9 | Pro | 60 mg |
| | Ile | 40 mg |
| | Lys | 60 mg |
| Amino acid composition of | Val | 50 mg |
| reaction solution I-10 | Pro | 60 mg |
| | Ile | 30 mg |
| | Glu | 400 mg |
| Amino acid composition of | Val | 50 mg |
| reaction solution I-11 | Pro | 60 mg |
| | Lys | 60 mg |
| | Glu | 400 mg |
| Amino acid composition of | Val | 50 mg |
| reaction solution I-12 | Ile | 30 mg |
| | Lys | 60 mg |
| | Glu | 400 mg |
| Amino acid composition of | Pro | 60 mg |
| reaction solution I-13 | Ile | 30 mg |
| | Lys | 60 mg |
| | Glu | 400 mg |
| Amino acid composition of | Val | 50 mg |
| reaction solution I-14 | Pro | 60 mg |
| | Ile | 40 mg |
| | Arg | 70 mg |
| Amino acid composition of | Val | 50 mg |
| reaction solution I-15 | Pro | 60 mg |
| | Lys | 60 mg |
| | Arg | 70 mg |
| Amino acid composition of | Val | 50 mg |
| reaction solution I-16 | Ile | 30 mg |
| | Lys | 60 mg |
| | Arg | 70 mg |
| Amino acid composition of | Pro | 60 mg |
| reaction solution I-17 | Ile | 30 mg |
| | Lys | 60 mg |
| | Arg | 70 mg |
| Amino acid composition of | Val | 50 mg |
| reaction solution I-18 | Pro | 60 mg |
| | Glu | 400 mg |
| | Arg | 60 mg |
| Amino acid composition of | Val | 50 mg |
| reaction solution I-19 | Ile | 30 mg |
| | Glu | 400 mg |
| | Arg | 60 mg |
| Amino acid composition of | Pro | 60 mg |
| reaction solution I-20 | Ile | 30 mg |
| | Glu | 400 mg |
| | Arg | 60 mg |
| Amino acid composition of | Val | 50 mg |
| reaction solution I-21 | Lys | 60 mg |
| | Glu | 400 mg |
| | Arg | 60 mg |
| Amino acid composition of | Pro | 60 mg |
| reaction solution I-22 | Lys | 60 mg |
| | Glu | 400 mg |
| | Arg | 60 mg |
| Amino acid composition of | Ile | 30 mg |
| reaction solution I-23 | Lys | 60 mg |
| | Glu | 400 mg |
| | Arg | 60 mg |
| Amino acid composition of | Val | 70 mg |
| reaction solution I-24 | Pro | 90 mg |
| | Ile | 60 mg |
| Amino acid composition of | Val | 70 mg |
| reaction solution I-25 | Pro | 90 mg |
| | Lys | 80 mg |
| Amino said composition of | Val | 55 mg |
| reaction solution I-26 | Pro | 70 mg |
| | Glu | 400 mg |
| Amino acid composition of | Val | 70 mg |
| reaction solution I-27 | Pro | 90 mg |
| | Arg | 90 mg |
| Amino said composition of | Val | 70 mg |
| reaction solution I-28 | Ile | 60 mg |
| | Lys | 80 mg |
| Amino acid composition of | Val | 55 mg |
| reaction solution I-29 | Ile | 50 mg |
| | Glu | 400 mg |
| Amino acid composition of | Val | 70 mg |
| reaction solution I-30 | Ile | 60 mg |
| | Arg | 90 mg |
| Amino acid composition of | Val | 55 mg |
| reaction solution I-31 | Lys | 70 mg |
| | Glu | 400 mg |
| Amino acid composition of | Val | 70 mg |
| reaction solution I-32 | Lys | 80 mg |
| | Arg | 90 mg |
| Amino acid composition of | Val | 55 mg |
| reaction solution I-33 | Glu | 400 mg |
| | Arg | 80 mg |
| Amino acid composition of | Pro | 90 mg |
| reaction solution I-34 | Ile | 60 mg |
| | Lys | 80 mg |
| Amino acid composition of | Pro | 70 mg |
| reaction solution I-35 | Ile | 50 mg |
| | Glu | 400 mg |
| Amino acid composition of | Pro | 90 mg |
| reaction solution I-36 | Ile | 60 mg |
| | Arg | 90 mg |
| Amino acid composition of | Pro | 70 mg |
| reaction solution I-37 | Lys | 70 mg |
| | Glu | 400 mg |
| Amino acid composition of | Pro | 90 mg |
| reaction solution I-38 | Lys | 80 mg |
| | Arg | 90 mg |
| Amino acid composition of | Pro | 70 mg |
| reaction solution I-39 | Glu | 400 mg |
| | Arg | 80 mg |
| Amino acid composition of | Ile | 50 mg |
| reaction solution I-40 | Lys | 70 mg |
| | Glu | 400 mg |
| Amino said composition of | Ile | 60 mg |
| reaction solution I-41 | Lys | 80 mg |
| | Arg | 90 mg |
| Amino acid composition of | Ile | 50 mg |
| reaction solution I-42 | Glu | 400 mg |
| | Arg | 80 mg |
| Amino acid composition of | Lys | 70 mg |
| reaction solution I-43 | Glu | 400 mg |
| | Arg | 80 mg |

Amino acids are indicated by three characters.

TABLE I-5
Amino acid composition of each reaction solution

| | | |
|---|---|---|
| Amino acid composition of | Arg | 50 mg |
| reaction solution I-44 | Lys | 50 mg |
| | Ile | 20 mg |
| | Val | 35 mg |
| | Pro | 45 mg |
| | Glu | 400 mg |
| | Gly | 50 mg |
| | Phe | 20 mg |
| | Ala | 90 mg |
| Amino acid composition of | Val | 70 mg |
| reaction solution I-45 | Ile | 60 mg |
| | Lys | 80 mg |
| | Gly | 40 mg |
| | Phe | 20 mg |
| Amino acid composition of | Arg | 50 mg |
| reaction solution I-46 | Lys | 50 mg |
| | Ile | 20 mg |
| | Val | 35 mg |
| | Pro | 45 mg |
| | Glu | 400 mg |
| | Gly | 250 mg |
| Amino acid composition of | Arg | 50 mg |
| reaction solution I-47 | Lys | 50 mg |
| | Ile | 20 mg |
| | Val | 35 mg |
| | Pro | 45 mg |
| | Glu | 400 mg |
| | Gly | 400 mg |
| Amino acid composition of | Arg | 50 mg |
| reaction solution I-48 | Lys | 50 mg |
| | Ile | 20 mg |
| | Val | 35 mg |
| | Pro | 45 mg |
| | Glu | 400 mg |
| | Gly | 600 mg |
| Amino acid composition of | Glu | 400 mg |
| reaction solution I-49 | | |
| Amino acid composition of | Pro | 60 mg |
| reaction solution I-50 | | |
| Amino acid composition of | Glu | 400 mg |
| reaction solution I-51 | Arg | 50 mg |
| Amino acid composition of | Val | 60 mg |
| reaction solution I-52 | Leu | 60 mg |
| | Ile | 60 mg |
| Amino acid composition of | Arg | 90 mg |
| reaction solution I-53 | Lys | 90 mg |
| Amino acid composition of | Glu | 180 mg |
| reaction solution I-54 | Cys | 20 mg |
| | Met | 60 mg |
| | Leu | 180 mg |
| | Arg | 160 mg |
| Amino acid composition of | Glu | 120 mg |
| reaction solution I-55 | Leu | 48 mg |
| | Ala | 45 mg |
| | Ser | 25 mg |
| | Arg | 25 mg |
| | Tyr | 18 mg |
| | Phe | 18 mg |
| | His | 12 mg |
| | Met | 10 mg |

Amino acids are indicated by three characters.

TABLE I-6
Rating by organoleptic evaluation

| | | Rating by |
|---|---|---|
| Item | Reaction solution | organoleptic evaluation |
| Control Example I-1 | Water | 1.9 |
| Example I-3 | reaction solution I-3 | 3.3 |
| Example I-4 | reaction solution I-4 | 3.4 |
| Example I-5 | reaction solution I-5 | 3.1 |
| Example I-6 | reaction solution I-6 | 3.2 |
| Example I-7 | reaction solution I-7 | 3.3 |
| Example I-8 | reaction solution I-8 | 3.0 |
| Example I-9 | reaction solution I-9 | 3.1 |
| Example I-10 | reaction solution I-10 | 3.2 |
| Example I-11 | reaction solution I-11 | 3.4 |
| Example I-12 | reaction solution I-12 | 3.2 |
| Example I-13 | reaction solution I-13 | 3.0 |
| Example I-14 | reaction solution I-14 | 3.1 |
| Example I-15 | reaction solution I-15 | 3.2 |
| Example I-16 | reaction solution I-16 | 3.2 |
| Example I-17 | reaction solution I-17 | 3.1 |
| Example I-18 | reaction solution I-18 | 3.3 |
| Example I-19 | reaction solution I-19 | 3.0 |
| Example I-20 | reaction solution I-20 | 3.1 |
| Example I-21 | reaction solution I-21 | 3.2 |
| Example I-22 | reaction solution I-22 | 3.1 |
| Example I-23 | reaction solution I-23 | 3.2 |
| Example I-24 | reaction solution I-24 | 3.1 |
| Example I-25 | reaction solution I-25 | 3.0 |
| Example I-26 | reaction solution I-26 | 3.0 |
| Example I-27 | reaction solution I-27 | 2.9 |
| Example I-28 | reaction solution I-28 | 3.1 |
| Example I-29 | reaction solution I-29 | 3.2 |
| Example I-30 | reaction solution I-30 | 3.1 |
| Example I-31 | reaction solution I-31 | 2.9 |
| Example I-32 | reaction solution I-32 | 3.1 |
| Example I-33 | reaction solution I-33 | 3.1 |
| Example I-34 | reaction solution I-34 | 3.2 |
| Example I-35 | reaction solution I-35 | 2.9 |
| Example I-36 | reaction solution I-36 | 3.3 |
| Example I-37 | reaction solution I-37 | 3.2 |
| Example I-38 | reaction solution I-38 | 3.0 |
| Example I-39 | reaction solution I-39 | 3.2 |
| Example I-40 | reaction solution I-40 | 3.1 |
| Example I-41 | reaction solution I-41 | 2.9 |
| Example I-42 | reaction solution I-42 | 3.2 |
| Example I-43 | reaction solution I-43 | 2.9 |
| Example I-44 | reaction solution I-44 | 2.9 |
| Example I-45 | reaction solution I-45 | 3.0 |
| Example I-46 | reaction solution I-46 | 3.3 |
| Example I-47 | reaction solution I-47 | 2.7 |
| Example I-48 | reaction solution I-48 | 2.3 |
| Comparative Example I-2 | reaction solution I-49 | 2.1 |
| Comparative Example I-3 | reaction solution I-50 | 2.2 |
| Comparative Example I-4 | reaction solution I-51 | 1.8 |
| Comparative Example I-5 | reaction solution I-52 | 1.7 |
| Comparative Example I-6 | reaction solution I-53 | 1.8 |
| Comparative Example I-7 | reaction solution I-54 | 1.9 |
| Comparative Example I-8 | reaction solution I-55 | 2.0 |

TABLE I-7

| Material | Blending amount |
|---|---|
| Wheat flour | 100 |
| Sugar | 46 |
| Skim milk powder | 3 |
| Salt | 0.6 |
| Baking soda | 0.4 |
| Ammonium bicarbonate | 0.5 |
| Shortening | 30 |
| Water | 25 |
| Total | 205.5 |

TABLE I-8

| Material | Blending amount |
|---|---|
| Wheat flour | 100 |
| Sugar | 46 |
| Skim milk powder | 3 |
| Salt | 0.6 |
| Baking soda | 0.4 |
| Ammonium bicarbonate | 0.5 |
| Shortening | 30 |
| Water | 25 |
| Powder of reaction | 0.1 |
| solution I-1 | |
| Total | 205.6 |

TABLE I-9

| Material | Blending amount |
|---|---|
| Wheat flour | 100 |
| Sugar | 46 |
| Skim milk powder | 3 |
| Salt | 0.6 |
| Baking soda | 0.4 |
| Ammonium bicarbonate | 0.5 |
| Shortening | 30 |
| Water | 25 |
| Powder of test solution I-1 | 0.1 |
| Total | 205.6 |

TABLE I-10

| | Rating by organoleptic |
|---|---|
| Item | evaluation |
| Control Example I-2 | 3.9 |
| Example I-49 | 4.6 |
| Comparative Example I-9 | 4.1 |

TABLE I-11

| | Rating by organoleptic |
|---|---|
| Item | evaluation |
| Control Example I-3 | 3.8 |
| Example I-50 | 4.4 |
| Comparative Example I-10 | 4.0 |

TABLE I-12

| | Rating by organoleptic |
|---|---|
| Item | evaluation |
| Control Example I-4 | 3.7 |
| Example I-51 | 4.6 |
| Comparative Example I-11 | 4.0 |

TABLE II-1
Amino acid composition of
reaction solution A

| | | |
|---|---|---|
| Arginine | 50 | mg |
| Lysine | 50 | mg |
| Isoleucine | 20 | mg |
| Valine | 35 | mg |
| Proline | 45 | mg |
| Glutamic acid | 400 | mg |

TABLE II-2
Amino acid composition of
reaction solution B

| | | |
|---|---|---|
| Arginine | 60 | mg |
| Lysine | 60 | mg |
| Isoleucine | 35 | mg |
| Valine | 45 | mg |
| Glutamic acid | 400 | mg |

TABLE II-3
Amino acid composition of
reaction solution C

| | | |
|---|---|---|
| Arginine | 70 | mg |
| Lysine | 70 | mg |
| Valine | 60 | mg |
| Glutamic acid | 400 | mg |

TABLE II-4
Amino acid composition of
reaction solution D

| | | |
|---|---|---|
| Glycine | 45 | mg |
| Alanine | 50 | mg |
| Leucine | 20 | mg |
| Phenylalanine | 35 | mg |
| Glutamic acid | 400 | mg |
| Arginine | 50 | mg |

TABLE II-5
Amino acid composition of
reaction solution E

| | | |
|---|---|---|
| Tyrosine | 50 | mg |
| Aspartic acid | 60 | mg |
| Tryptophan | 30 | mg |
| Glutamic acid | 400 | mg |
| Arginine | 60 | mg |

TABLE II-6
Amino acid composition of
reaction solution F

| | | |
|---|---|---|
| Arginine | 300 | mg |
| Lysine | 300 | mg |

TABLE II-7
Amino acid composition of
reaction solution G

| | | |
|---|---|---|
| Lysine | 600 | mg |

TABLE II-8
Amino acid composition of
reaction solution H

| | | |
|---|---|---|
| Arginine | 600 | mg |

TABLE II-9
Amino acid composition of
reaction solution I

| | | |
|---|---|---|
| Glutamic acid | 600 | mg |

TABLE II-10
Amino acid composition of
reaction solution J

| | | |
|---|---|---|
| Arginine | 50 | mg |
| Lysine | 50 | mg |
| Isoleucine | 20 | mg |
| Valine | 35 | mg |
| Proline | 45 | mg |
| Glutamic acid | 400 | mg |

(Without heat treatment)

TABLE II-11

| | | Comparative | Example | | | | | | |
|---|---|---|---|---|---|---|---|---|---|
| | | Example II-1 | II-1 | II-2 | II-3 | II-4 | II-5 | II-6 | II-7 |
| Raw | Sugar | 500 | 500 | 500 | 500 | 500 | 500 | 500 | 450 |
| material | Glutinous starch syrup | 400 | 400 | 400 | 400 | 400 | 400 | 400 | 400 |
| | Fresh cream | 100 | 100 | 100 | 100 | 100 | 100 | 50 | 100 |
| | Butter | 20 | 20 | 20 | 20 | 20 | 20 | 10 | 20 |
| | Condensed milk | 70 | 70 | 70 | 70 | 70 | 70 | 35 | 70 |
| | Caramel powder | | | | | | | | 50 |
| | Emulsifier | 1.0 | 1.0 | 1.0 | 1.0 | 1.0 | 1.0 | 1.0 | 1.0 |
| Kinds of the amino acids in milk | | | Valine | Valine | Valine | Valine | Valine | Valine | Valine |
| taste-enhancing food ingredient | | | Proline | | | Proline | Proline | Proline | Praline |
| | | | Isoleucine | Isoleucine | | Isoleucine | Isoleucine | Isoleucine | Isoleucine |
| | | | Lysine | Lysine | Lysine | Lysine | Lysine | Lysine | Lysine |
| | | | Glutamic | Glutamic | Glutamic | Glutamic | Glutamic | Glutamic | Glutamic |
| | | | acid | acid | acid | acid | acid | acid | acid |
| | | | Arginine | Arginine | Arginine | Arginine | Arginine | Arginine | Arginine |
| Amino acid solid matter content | | 0 | 0.04 | 0.04 | 0.04 | 0.002 | 3.95 | 0.04 | 0.04 |
| in milk taste-enhancing food | | | | | | | | | |
| ingredient (%) | | | | | | | | | |
| Milk taste enhancement | | — | ⊚ | ⊚ | ⊚ | ◯ | ◯ | ⊚ | ⊚ |
| | | Comparative | Example | | | | | | |
| | | Example II-2 | II-8 | II-9 | II-10 | II-11 | | | |
| Raw | Glutinous reducing | 1000 | 1000 | | | 500 | | | |
| material | maltose isyrup | | | | | | | | |
| | Glutinous reducing | | | 1000 | | 500 | | | |
| | starch syrup | | | | | | | | |
| | Reducing palatinose | | | | 1000 | | | | |
| | Fresh cream | 100 | 100 | 100 | 100 | 100 | | | |
| | Butter | 20 | 20 | 20 | 20 | 20 | | | |
| | Emulsifier | 1.0 | 1.0 | 1.0 | 1.0 | 1.0 | | | |

| | | | | | |
|---|---|---|---|---|---|
| Kinds of the amino acids in milk | | Valine | Valine | Valine | Valine |
| taste-enhancing food ingredient | | Proline | Proline | Proline | Proline |
| | | Isoleucine | Isoleucine | Isoleucine | Isoleucine |
| | | Lysine | Lysine | Lysine | Lysine |
| | | Glutamic | Glutamic | Glutamic | Glutamic |
| | | acid | acid | acid | add |
| | | Arginine | Arginine | Arginine | Arginine |
| Amino acid solid matter content | 0 | 0.04 | 0.04 | 0.04 | 0.04 |
| in milk taste-enhancing food | | | | | |
| ingredient (%) | | | | | |
| Milk taste enhancement | — | ⊚ | ⊚ | ⊚ | ⊚ |

TABLE II-12

| | | Comparative Example | | | | | | | | | |
|---|---|---|---|---|---|---|---|---|---|---|---|
| | | II-1 | II-2 | II-3 | II-4 | II-5 | II-6 | II-7 | II-8 | II-9 | II-10 |
| Raw | Sugar | 500 | 500 | 500 | 500 | 500 | 500 | 500 | 500 | 500 | 500 |
| material | Glutinous starch | 400 | 400 | 400 | 400 | 400 | 400 | 400 | 400 | 400 | 400 |
| | syrup | | | | | | | | | | |
| | Fresh cream | 100 | 100 | 100 | 100 | 100 | 100 | 100 | 100 | 100 | 100 |
| | Butter | 20 | 20 | 20 | 20 | 20 | 20 | 20 | 20 | 20 | 20 |
| | Condensed milk | 70 | 70 | 70 | 70 | 70 | 70 | 70 | 70 | 70 | 70 |
| | Emulsifier | 1.0 | 1.0 | 1.0 | 1.0 | 1.0 | 1.0 | 1.0 | 1.0 | 1.0 | 1.0 |

| | | | | | | | | | | |
|---|---|---|---|---|---|---|---|---|---|---|
| Kinds of the amino acids in | Glycine | Tyrosine | Lysine | Lysine | Arginine | Glutamic | Valine | Valine | | Valine |
| milk taste-enhancing food | | | | | | acid | | | | |
| ingredient | Alanine | Aspartic | Arginine | | | | Proline | Proline | | Proline |
| | | acid | | | | | | | | |
| | Leucine | Tryptophan | | | | | Isoleucine | Isoleucine | | Isoleucine |
| | Phenyl- | Glutamic | | | | | Lysine | Lysine | | Lysine |
| | alanine | acid | | | | | | | | |
| | Glutamic | Arginine | | | | | Glutamic | Glutamic | | Glutamic |
| | acid | | | | | | acid | acid | | acid |
| | Arginine | | | | | | Arginine | Arginine | | Arginine |
| Amino acid solid matter | 0.04 | 0.04 | 0.04 | 0.04 | 0.04 | 0.04 | 0.0004 | 1.1 | 0.04 | 0.04 |
| content in milk taste-enhancing | | | | | | | | | | |
| food ingredient (%) | | | | | | | | | | |
| Milk taste enhancement | X | X | X | X | X | X | X | X | X | Δ |

1. A food ingredient having milk taste-enhancing action, prepared by heating an aqueous solution containing an amino acid mixture containing at least three kinds of amino acids selected from valine, proline, isoleucine, lysine, glutamic acid, and arginine as the principal components and a carbohydrate.

2. The food ingredient having milk taste-enhancing action according to claim 1, wherein the total amount of the at least three kinds of amino acids selected from valine, proline, isoleucine, lysine, glutamic acid and arginine is 70 wt % or more with respect to the total amount of all amino acids.

3. The food ingredient having milk taste-enhancing action according to claim 2, wherein the amino acids selected are valine, proline, isoleucine, lysine, glutamic acid and arginine.

4. A method of producing the food ingredient having milk taste-enhancing action according to claim 3, comprising a step of mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components.

5. A method of enhancing the milk taste of a food or seasoning, characterized by adding the food ingredient having milk taste-enhancing action according to claim 4 to the food or the seasoning to a final solid matter concentration of 1 ppm to 10,000 ppm.

6. A milk taste-enhanced milk-based hard candy having a carbohydrate and a dairy product as the principal components, characterized by containing the food ingredient having milk taste-enhancing action according to claim 5 in an amount as solid matter of 0.001 to 1.0 wt %.

7. The milk taste-enhanced milk-based hard candy according to claim 6, wherein the carbohydrate used in preparation of the hard candy is one or more compounds selected from the group consisting of glutinous reducing maltose syrup, glutinous reducing starch syrup, reducing palatinose, xylitol, erythritol, lactitol, mannitol, and sorbitol.

8. A method of producing the milk taste-enhanced milk-based hard candy according to claim 7, characterized by having a step of obtaining a food ingredient having milk taste-enhancing action by mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components, and a step of mixing and dissolving the food ingredient with a carbohydrate and a dairy product under heat and then concentrating the solution under heat.

9. The food ingredient having milk taste-enhancing action according to claim 1, wherein the amino acids selected are valine, proline, isoleucine, lysine, glutamic acid and arginine.

10. A method of producing the food ingredient having milk taste-enhancing action according to claim 9, comprising a step of mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components.

11. A method of enhancing the milk taste of a food or seasoning, characterized by adding the food ingredient having milk taste-enhancing action according to claim 10 to the food or the seasoning to a final solid matter concentration of 1 ppm to 10,000 ppm.

12. A milk taste-enhanced milk-based hard candy having a carbohydrate and a dairy product as the principal components, characterized by containing the food ingredient having milk taste-enhancing action according to claim 11 in an amount as solid matter of 0.001 to 1.0 wt %.

13. The milk taste-enhanced milk-based hard candy according to claim 12, wherein the carbohydrate used in preparation of the hard candy is one or more compounds selected from the group consisting of glutinous reducing maltose syrup, glutinous reducing starch syrup, reducing palatinose, xylitol, erythritol, lactitol, mannitol, and sorbitol.

14. A method of producing the milk taste-enhanced milk-based hard candy according to claim 13, characterized by having a step of obtaining a food ingredient having milk taste-enhancing action by mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components, and a step of mixing and dissolving the food ingredient with a carbohydrate and a dairy product under heat and then concentrating the solution under heat.

15. A method of producing the food ingredient having milk taste-enhancing action according to claim 1, comprising a step of mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components.

16. A method of enhancing the milk taste of a food or seasoning, characterized by adding the food ingredient having milk taste-enhancing action according to claim 1 to the food or the seasoning to a final solid matter concentration of 1 ppm to 10,000 ppm.

17. A milk taste-enhanced milk-based hard candy having a carbohydrate and a dairy product as the principal components, characterized by containing the food ingredient having milk taste-enhancing action according to claim 1 in an amount as solid matter of 0.001 to 1.0 wt %.

18. The milk taste-enhanced milk-based hard candy according to claim 17, wherein the carbohydrate used in preparation of the hard candy is one or more compounds selected from the group consisting of glutinous reducing maltose syrup, glutinous reducing starch syrup, reducing palatinose, xylitol, erythritol, lactitol, mannitol, and sorbitol.

19. A method of producing the food ingredient having milk taste-enhancing action according to claim 2, comprising a step of mixing an amino acid mixture containing at least three kinds of amino acids selected from valine, proline, isoleucine, lysine, glutamic acid, and arginine as the principal components and a carbohydrate with water, heating the aqueous mixed solution under an open system at 70° C. to 150° C., and evaporating the generated fragrance components.

20. A method of enhancing the milk taste of a food or seasoning, characterized by adding the food ingredient having milk taste-enhancing action according to claim 2 to the food or the seasoning to a final solid matter concentration of 1 ppm to 10,000 ppm.

21. A milk taste-enhanced milk-based hard candy having a carbohydrate and a dairy product as the principal components, characterized by containing the food ingredient having milk taste-enhancing action according to claim 2 in an amount as solid matter of 0.001 to 1.0 wt %.

22. The milk taste-enhanced milk-based hard candy according to claim 21, wherein the carbohydrate used in preparation of the hard candy is one or more compounds selected from the group consisting of glutinous reducing maltose syrup, glutinous reducing starch syrup, reducing palatinose, xylitol, erythritol, lactitol, mannitol, and sorbitol.
